(19) United States
(12) Patent Application Publication
(10) Pub. No.: US 2024/0380681 A1
(43) Pub. Date: Nov. 14, 2024

(54) METHOD AND APPARATUS FOR REPORTING UPLINK TRAFFIC JITTER IN WIRELESS COMMUNICATION SYSTEM

(71) Applicant: Samsung Electronics Co., Ltd., Suwon-si (KR)

(72) Inventors: Hyunjeong KANG, Suwon-si (KR); Beomsik BAE, Suwon-si (KR); Taeseop LEE, Suwon-si (KR)

(21) Appl. No.: 18/661,023

(22) Filed: May 10, 2024

(30) Foreign Application Priority Data
May 10, 2023 (KR) 10-2023-0060694

(51) Int. Cl. H04L 43/087; H04L 43/06; H04W 28/02

(52) U.S. Cl. CPC H04L 43/087; H04L 43/06; H04W 28/0268

(57) ABSTRACT

The disclosure relates to a fifth-generation (5G) or a sixth-generation (6G) communication system for supporting a higher data transmission rate. A method performed by a user equipment (UE) in a wireless communication system is provided. The method includes receiving, from a base station, a first message including a configuration associated with a jitter report of an uplink traffic, transmitting, to the base station, a second message including the jitter report, wherein the configuration includes at least one of information on a protocol data unit (PDU) session or information on a timer.

### CROSS-REFERENCE TO RELATED APPLICATION(S)

This application is based on and claims priority under 35 U.S.C. § 119 (a) of a Korean patent application number 10-2023-0060694, filed on May 10, 2023, in the Korean Intellectual Property Office, the disclosure of which is incorporated by reference herein in its entirety.

### BACKGROUND

### 1. Field

The disclosure relates to an operation of a user equipment (UE) in a wireless communication system. More particularly, the disclosure relates to a method and an apparatus for efficiently serving application data traffic in a wireless communication system.

### 2. Description of Related Art

5^{th} generation (5G) mobile communication technologies define broad frequency bands such that high transmission rates and new services are possible, and can be implemented not only in “Sub 6 gigahertz (GHz)” bands, such as 3.5 GHZ, but also in “Above 6 GHz” bands referred to as millimeter-wave (mmWave) including 28 GHz and 39 GHz. In addition, it has been considered to implement 6^{th} generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to effectively provide these services.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method for effectively providing a service in a wireless communication system.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, from a base station, a first message including a configuration associated with a jitter report of an uplink traffic, and transmitting, to the base station, a second message including the jitter report, wherein the configuration includes at least one of information on a protocol data unit (PDU) session or information on a timer.

In an embodiment of the disclosure, wherein the information on the PDU session includes at least one of PDU session identifier or quality of service (QOS) flow identifier, and wherein the timer is associated with T346x.

In an embodiment of the disclosure, wherein the jitter report includes information on an uplink traffic, and wherein the information on uplink traffic includes at least one of a PDU session identifier or information on a QoS flow.

In an embodiment of the disclosure, wherein the information on a QoS flow includes at least one of a QoS flow identifier (QFI), a jitter range, or a traffic periodicity.

In an embodiment of the disclosure, wherein the second message includes a UEAssistanceInformation message.

In accordance with another aspect of the disclosure, a method performed by a base station in a wireless communication system is provided. The method includes transmitting, to a user equipment (UE), a first message including a configuration associated with a jitter report of an uplink traffic, and receiving, from the UE, a second message including the jitter report, wherein the configuration includes at least one of information on a protocol data unit (PDU) session or information on a timer.

In accordance with another aspect of the disclosure, a user equipment (UE) in a wireless communication system is provided. The UE includes a transceiver, memory storing one or more computer programs, and one or more processors communicatively coupled to the transceiver and the memory, wherein the one or more computer programs include computer-executable instructions that, when executed by the one or more processors, cause the UE to receive, from a base station, a first message including a configuration associated with a jitter report of an uplink traffic, and transmit, to the base station, a second message including the jitter report, wherein the configuration includes at least one of information on a protocol data unit (PDU) session or information on a timer.

In accordance with another aspect of the disclosure, a base station in a wireless communication system is provided. The base station includes a transceiver, memory storing one or more computer programs, and one or more processors communicatively coupled the transceiver and the memory, wherein the one or more computer programs include computer-executable instructions that, when executed by the one or more processors, cause the base station to transmit, to a user equipment (UE), a first message including a configuration associated with a jitter report of an uplink traffic, and receive, from the UE, a second message including the jitter report, wherein the configuration includes at least one of information on a protocol data unit (PDU) session or information on a timer.

In accordance with another aspect of the disclosure, one or more non-transitory computer-readable storage media storing computer-executable instructions that, when executed by one or more processors of a user equipment (UE), cause the UE to perform operations are provided. The operations include receiving, from a base station, a first message including a configuration associated with a jitter report of an uplink traffic, and transmitting, to the base station, a second message including the jitter report, wherein the configuration includes at least one of information on a protocol data unit (PDU) session or information on a timer.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a new radio (NR) system according to an embodiment of the disclosure;

FIG. 2 illustrates a wireless protocol structure in long term evolution (LTE) and NR systems according to an embodiment of the disclosure;

FIG. 3 illustrates signaling through which a user equipment (UE) reports jitter for uplink traffic to a network according to an embodiment of the disclosure;

FIG. 4 illustrates signaling through which a UE reports jitter for uplink traffic to a network according to an embodiment of the disclosure;

FIG. 5 illustrates signaling through which a UE reports jitter for uplink traffic to a network according to an embodiment of the disclosure;

FIG. 6 illustrates signaling through which a UE reports jitter for uplink traffic to a network according to an embodiment of the disclosure;

FIG. 7 illustrates a structure of a base station according to an embodiment of the disclosure;

FIG. 8 illustrates a structure of a UE according to an embodiment of the disclosure; and

FIG. 9 illustrates a structure of a core network entity according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Furthermore, the “unit” in the embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description, the terms “physical channel” and “signal” may be interchangeably used with the term “data” or “control signal”. For example, the term “physical downlink shared channel (PDSCH)” refers to a physical channel over which data is transmitted, but the PDSCH may also be used to refer to the “data”. For example, in the disclosure, the expression “transmit ting a physical channel” may be construed as having the same meaning as the expression “transmitting data or a signal over a physical channel”.

In the following description of the disclosure, higher signaling refers to a signal transfer scheme from a base station to a terminal via a downlink data channel of a physical layer, or from a terminal to a base station via an uplink data channel of a physical layer. The higher signaling may also be understood as radio resource control (RRC) signaling or a media access control (MAC) control element (CE).

In the following description of the disclosure, terms and names defined in the 3^{rd} generation partnership project new radio (3GPP NR) or 3^{rd} generation partnership project long term evolution (3GPP LTE) standards will be used for the sake of descriptive convenience. However, the disclosure is not limited by these terms and names, and may be applied in the same way to systems that conform other standards. In the disclosure, the term “gNB” may be interchangeably used with the term “eNB” for the sake of descriptive convenience. For example, a base station described as “eNB” may indicate “gNB”. In addition, the term “terminal” may refer to mobile phones, MTC devices, NB-IoT devices, sensors, and other wireless communication devices.

In the following description, a base station is an entity that allocates resources to terminals, and may be at least one of a gNode B (gNB), an eNode B (eNB), a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, examples of the base station and the terminal are not limited thereto.

The disclosure relates to a method and an apparatus for processing uplink jitter that may be generated when a UE transmits a packet to a base station in a next-generation wireless communication system. More particularly, the disclosure relates to a method and an apparatus for reflecting reported jitter information to perform scheduling of the UE in the base station and a core network entity and efficiently use network radio resources by reporting jitter information to the base station or the core network entity when jitter is generated in a codec for processing application data generated in the UE or when jitter is generated in a non-3GPP communication link (for example, wireless local area network (WLAN), Bluetooth, or the like) in which the UE is using tethering.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

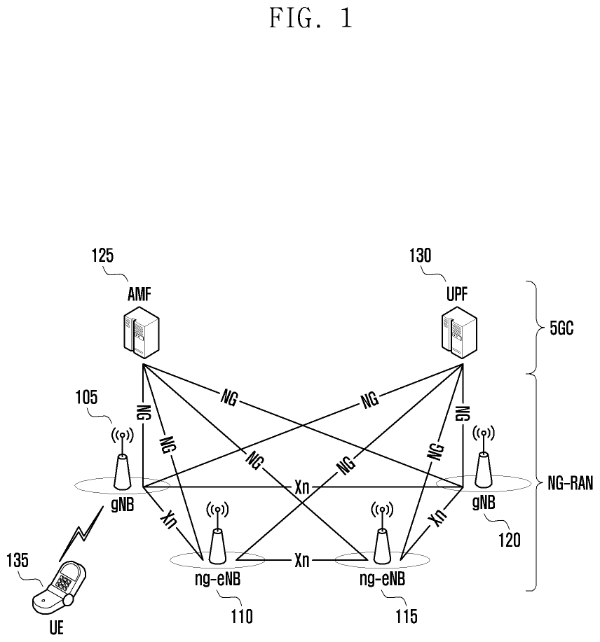

FIG. 1 illustrates a structure of an NR system according to an embodiment of the disclosure.

Referring to FIG. 1, a wireless communication system may include a plurality of base stations (for example, a gNB 105, an ng-eNB 110, an ng-eNB 115, and a gNB 120), an access and mobility management function (AMF) 125, and a user plane function (UPF) 130. A user equipment 135 (UE or terminal) may access an external network through the base stations (for example, the gNB 105, the ng-eNB 110, the ng-eNB 115, and the gNB 120) and the UPF 130.

In FIG. 1, the base stations (for example, the gNB 105, the ng-eNB 110, the ng-eNB 115, and the gNB 120) may provide radio access to UEs accessing the network as access nodes of the cellular network. For example, the base stations (for example, the gNB 105, the ng-eNB 110, the ng-eNB 115, and the gNB 120) may collect and schedule status information of buffer statuses of UEs, available transmission power statuses, channel statuses, and the like to serve traffic of users and support the connection between the UEs and a core network (CN). Meanwhile, in communication, a user plane (UP) related to real transmission of user data and a control plane (CP) related to connection management may be separately configured, and the gNB 105 and the gNB 120 may use UP and CP technologies defined in NR technology and the ng-eNB 110 and the ng-eNB 115 are connected to the 5^{th} generation core (5GC) but may use the UP and CP technologies defined in LTE technology in the drawings. The 5GC may be a CN in the NR system.

The AMF 125 is a device that performs not only a mobility management function for the UE but also various control functions and may be connected to a plurality of base stations, and the UPF 130 may be a kind of gateway that provides data transmission. Although not illustrated in FIG. 1, the NR communication system may include a session management function (SMF). The SMF may manage a packet data network connection, such as a protocol data unit (PDU) session.

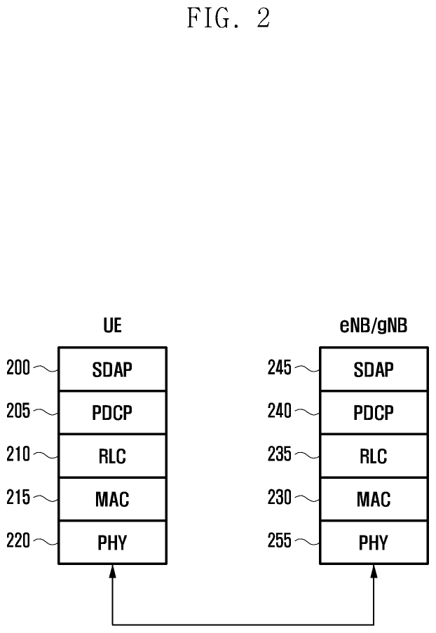

FIG. 2 illustrates a wireless protocol structure in LTE and NR systems according to an embodiment of the disclosure.

Referring to FIG. 2, the wireless protocol in the NR system may include a service data adaptation protocol (SDAP) 200 or 245, a packet data convergence protocol (PDCP) 205 or 240, a radio link control (RLC) 210 or 235, and a medium access control (MAC) 215 or 230 in each of the UE and the gNB. The SADP 200 or 255 may perform an operation for mapping each QoS flow to a specific data radio bearer (DRB), and an SDAP configuration corresponding to each DRB may be given from a higher layer (for example, an RRC layer). The PDCP 205 or 240 may perform an operation of compressing and/or reconstructing an IP header, and the RLC 210 or 235 may reconfigure a PDCP PDU to be the appropriate size. The MAC 215 or 230 may be connected to a plurality of RLC layer devices configured in one UE, and may perform an operation of multiplexing RLC PDUs to a MAC PDU and demultiplexing RLC PDUs from a MAC PDU. The physical layer (PHY) 220 or 225 may perform an operation of channel-coding and modulating higher-layer data to generate orthogonal frequency-division multiplexing (OFDM) symbols and transmitting the OFDM symbols through a radio channel or demodulating and channel-decoding the OFDM symbols received through the radio channel and transmitting the demodulated and channel-decoded OFDM symbols to the higher layer. Further, the physical layer 220 or 225 may use a hybrid automatic repeat request (HARQ) for additional error correction, and a receiving side may transmit, through 1 bit, information indicating whether a packet transmitted from a transmitting side has been received. The information indicating whether the receiving side has received the packet from the transmitting side may be HARQ ACK/NACK information. In the case of the LTE system, downlink HARQ ACK/NACK information for uplink data transmission may be transmitted through a physical hybrid-arq indicator channel (PHICH). In the case of the NR system, downlink HARQ ACK/NACK information for uplink data transmission may be transmitted through a physical dedicated control channel (PDCCH) corresponding to a channel through which downlink and/or uplink resource allocation or the like is transmitted, and the base station may determine whether retransmission is needed through scheduling information of the UE or whether to perform new transmission. Unlike LTE, the reason why the base station determines whether retransmission is need through scheduling information of the UE and whether to perform new transmission in the NR system is that non-synchronous HARQ is applied in NR. The uplink HARQ ACK/NACK information for downlink data transmission may be transmitted through a physical channel, such as a physical uplink control channel (PUCCH) or a physical uplink shared channel (PUSCH). The PUCCH may be generally transmitted in an uplink of a primary cell (PCell) described below. However, when supported by the UE, HARQ ACK/NACK information for a secondary cell (SCell) described below may be transmitted in which case the SCell is referred to as a PUCCH SCell.

Although not illustrated, there may be a radio resource control (RRC) layer above the PDCP layer of each of the UE and the base station, and the RRC layer may exchange an access- and measurement-related configuration control message to control radio resources.

Meanwhile, the PHY layer may include one or a plurality of frequencies and/or carriers, and a technology for simultaneously configuring and using a plurality of frequencies may be referred to as carrier aggregation (CA). The CA technology may increase an amount of transmission by the number of subcarriers by using a main carrier and one or a plurality of subcarriers in addition to one carrier for communication between the UE and the base station (for example, the eNB or the gNB). Meanwhile, a cell within the base station using a main carrier in the LTE and NR systems may be referred to as a primary cell or a PCell, and a cell within a base station using a subcarrier may be referred to as a secondary cell or an SCell.

When the UE transmits image-based traffic or transmits POSE control information for controlling POSE while making an extended reality (XR) service, for example, a video call or an audio call, the UE may transmit traffic from a tethered device (for example, smart glasses or the like) connected through a non-3GPP link to the base station or transmit traffic processed through the application of the video codec to the base station. At this time, jitter due to the non-3GPP link may be generated when traffic is transferred from the tethered device connected through the non-3GPP link to the UE, or jitter due to the codec may be generated when traffic is processed through the application of the video codec. However, since the base station and the core network do not have jitter information due to the non-3GPP link connection of the UE or jitter information due to the codec, the base station may depend on uplink traffic information (for example, an uplink traffic period) provided by the core network to schedule uplink resources to the UE. When the UE experiences jitter due to the non-3GPP link connection or jitter due to the traffic codec, uplink traffic may wait in the UE transmission buffer before uplink resources allocated by the base station and uplink transmission may wait in the UE transmission buffer after uplink resources allocated by the base station. When traffic is generated before uplink resources, a traffic delivery delay may occur, and when traffic is generated after uplink resources, allocated resources may not be used and thus the resources may be thrown out. Accordingly, a method by which the base station and the core network receive jitter information that may be generated by uplink traffic of the UE and optimize scheduling by using the jitter information is required. The jitter information reported by the UE may help the base station in operating uplink traffic transmission resource allocation in a connected state-discontinuous reception mode (C-DRX) as well allocating (scheduling) to transmit uplink traffic of the BS. Jitter generated by uplink traffic may be different depending on the codec applied to the uplink traffic. Jitter generated by uplink traffic may be different depending on a non-3GPP link used for tethering by the UE. Accordingly, a jitter value may be different depending on QoS flow (or a PDU session or a DRB) corresponding to an application, a variation range of the jitter value may be different, and a period of a change in the jitter value may be different. Measurement of jitter generated by uplink traffic may depend on implementation of the UE, and a jitter value measured and reported to the base station and the core network by the UE may be expressed as a specific value or a range.

The UE may provide jitter information measured for uplink traffic to the network (base station or core network). Subsequently, methods by which the UE reports jitter information for uplink traffic to the base station or the core network are described with reference to various embodiments.

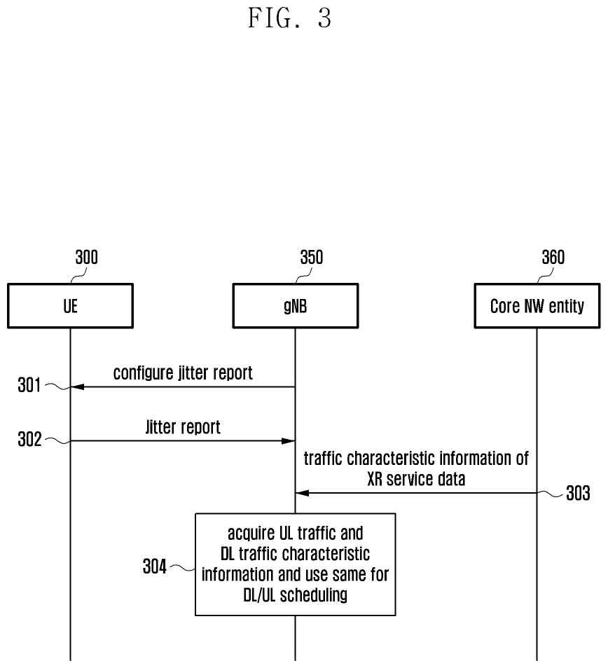

FIG. 3 illustrates signaling through which a UE reports jitter for uplink traffic to a network according to an embodiment of the disclosure.

Referring to FIG. 3, a UE 300 may receive configuration information for a jitter report on uplink traffic from a gNB 350 in operation 301. The configuration information in operation 301 may include information indicating that the UE may make the jitter report. The configuration information in operation 301 may include at least one or a combination of identification information of uplink traffic on which the UE can make the jitter report, for example, a QoS flow ID, a PDU session ID, a DRB ID, a logical channel ID, a logical channel group ID, and a configured grant configuration index. The configuration information in operation 301 may include at least one or a combination of periodic information of the jitter report made by the UE, for example, JitterReportingProhibitTimer configuration (JitterReport including the jitter report cannot be transmitted when the timer has not expired), a period through which the jitter report can be periodically made, threshold information of a jitter value making the jitter report, threshold information of jitter value variation making the jitter report, and delayBudgetReportingProhibitTimerXR configuration (delayBudgetReport including the jitter report cannot be transmitted when the timer has not expired). Although not illustrated in FIG. 3, before the gNB 350 transmits signaling of operation 301 to configure the uplink jitter report to the UE 300, the gNB 350 may receive a message informing that there is capability information for making the uplink jitter report from the UE 300. The message may be a UE capability message. When there is a jitter value measured for uplink traffic, based on the jitter report configuration information in operation 301, the UE 300 may report the measured jitter information to the gNB 350 in operation 302. When identification information for uplink traffic is included in the jitter report configuration in operation 301, the UE may report jitter measurement information for the corresponding uplink traffic to in operation 302. When period information for the jitter report is included in the jitter report configuration information in operation 301, the UE may transmit the jitter measurement report, based on the configured period information in operation 302. In operation 304, a core network 360 transmits traffic characteristic information of XR service data to the gNB 350. In operation 304, the gNB 350 may acquire traffic characteristic information of XR service data provided by the core network 360. The traffic characteristic information of the XR service data may be TSCAI_XR information. The traffic characteristic information of the XR service data acquired in operation 304 may include traffic characteristic information for uplink traffic and downlink traffic corresponding to the XR service. The traffic characteristic information may include, for example, at least one or a combination of a PDU session of the UE, a flow direction (downlink or uplink) for QoS flow, a downlink traffic period (DL periodicity), an uplink traffic period (UL periodicity), N6 jitter related to a downlink traffic period (DL periodicity), and burst arrival time. The gNB 350 may acquire, from the traffic characteristic information of the XR service in operation 304, uplink traffic characteristic information other than jitter corresponding to uplink traffic acquired from the UE 300 in operation 302. The gNB 350 may process the uplink jitter information in operation 302 and downlink scheduling and uplink scheduling for a DRB corresponding to each QoS flow and a C-DRX configuration by using the traffic characteristic information of the XR service data. Although not illustrated in FIG. 3, the gNB 350 may provide the core network 360 with jitter information for uplink traffic acquired from the UE 300 in operation 302, and the jitter information includes at least one or a combination of a PDU session mapped to uplink traffic, QoS flow, and UL jitter. Based on the jitter information, the core network 360 may configure traffic characteristic information of XR service data including UL jitter information for the PDU session mapped to the corresponding uplink traffic in the UE.

Although the embodiment of FIG. 3 describes an operation in which the UE 300 makes the jitter report in operation 302, based on the jitter report configuration information transmitted by the gNB 350 in operation 301, the UE 300 may make the jitter report without jitter report configuration information of the gNB 350 in another embodiment.

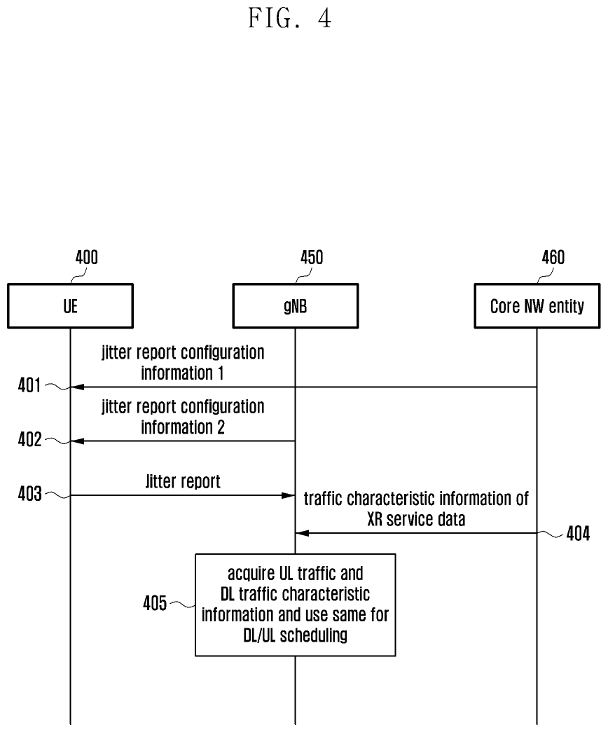

FIG. 4 illustrates signaling through which a UE reports jitter for uplink traffic to a network according to an embodiment of the disclosure.

Referring to FIG. 4, a UE 400 may receive jitter report configuration information for uplink traffic from a core network 460 in operation 401. The jitter report configuration information in operation 401 may include at least one or a combination of a PDU session ID corresponding to uplink traffic, a QoS flow ID, and UL traffic periodicity, and is information for which a request is made by the UE for the PDU session or QoS flow included in the configuration information in operation 401. The configuration information in operation 401 may include at least one or a combination of period information for making the jitter report by the UE, for example, a period for periodically making the jitter report, threshold information of a jitter value that makes the jitter report, and threshold information of a jitter value variation that performs the jitter report. The UE 400 may receive configuration information for making the jitter report for uplink traffic from a gNB 450 in operation 402. The configuration information in operation 402 may include information indicating that the UE may make the jitter report. The configuration information in operation 401 may include at least one or a combination of periodic information of the jitter report made by the UE, for example, JitterReportingProhibitTimer configuration (JitterReport including the jitter report cannot be transmitted when the timer has not expired), a period through which the jitter report can be periodically made, threshold information of a jitter value making the jitter report, threshold information of jitter value variation making the jitter report, and delay Budget Reporting Prohibit TimerXR configuration (delayBudgetReport including the jitter report cannot be transmitted when the timer has not expired). Although not illustrated in FIG. 4, before the gNB 450 transmits signaling in operation 402 to configure the uplink jitter report to the UE 400, the gNB 450 may receive a message informing that there is capability information for making the uplink jitter report from the UE 400. The message may be a UE capability. When there is the jitter value measured for uplink traffic, based on the jitter report configuration information in operation 401 and the jitter report configuration information in operation 402, the UE 400 may report measured jitter information to the gNB 450 in operation 403. When identification information for uplink traffic is included in the jitter report configuration information in operation 401, the UE may report jitter measurement information for the corresponding uplink traffic in operation 403. When period information for the jitter report is included in the jitter report configuration information received in operations 401 to 402, the UE may report the jitter measurement report, based on the configured period information in operation 403. In operation 404, the core network 460 transmits traffic characteristic information of XR service data to the gNB 450. In operation 405, the gNB 450 may acquire traffic characteristic information of XR service data provided by the core network 460. The traffic characteristic information of the XR service data may be TSCAI_XR information. The traffic characteristic information of the XR service data acquired in operation 405 may include traffic characteristic information for uplink traffic and downlink traffic corresponding to the XR service. The traffic characteristic information may include, for example, at least one or a combination of a PDU session of the UE, a flow direction (downlink or uplink) for QoS flow, a downlink traffic period (DL periodicity), an uplink traffic period (UL periodicity), N6 jitter related to a downlink traffic period (DL periodicity), and burst arrival time. The gNB 450 may acquire, from the traffic characteristic information of the XR service in operation 405, uplink traffic characteristic information other than jitter corresponding to uplink traffic acquired from the UE 400 in operation 403. The gNB 450 may process the uplink jitter information in operation 403 and downlink scheduling and uplink scheduling for a DRB corresponding to each QoS flow and a C-DRX configuration by using the traffic characteristic information of the XR service data. Although not illustrated in FIG. 4, the gNB 450 may provide the core network 460 with jitter information for uplink traffic acquired from the UE 400 in operation 403, and the jitter information includes at least one or a combination of a PDU session mapped to uplink traffic, QoS flow, UL jitter, and UL traffic periodicity. Based on the information, the core network 460 may configure traffic characteristic information of XR service data including UL jitter information for the PDU session mapped to the corresponding uplink traffic in the UE.

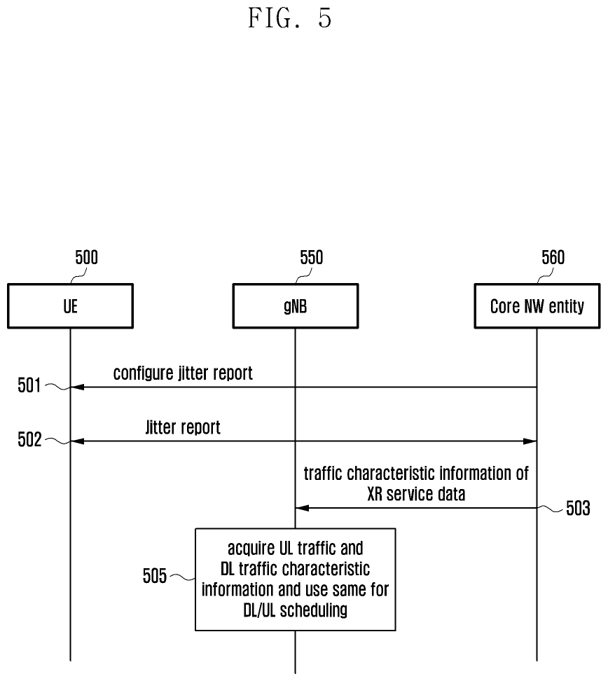

FIG. 5 illustrates signaling through which a UE reports jitter for uplink traffic to a network according to an embodiment of the disclosure.

Referring to FIG. 5, a UE 500 may receive jitter report configuration information for uplink traffic from a core network 560 in operation 501. The jitter report configuration information in operation 501 may include at least one or a combination of a PDU session ID corresponding to uplink traffic, a QoS flow ID, and UL traffic periodicity, and is information for which a request is made by the UE for the PDU session or QoS flow included in the configuration information in operation 501. The configuration information in operation 501 may include at least one or a combination of period information for making the jitter report by the UE, for example, a period for periodically making the jitter report, threshold information of a jitter value that makes the jitter report, and threshold information of a jitter value variation that performs the jitter report. When there is a jitter value measured for uplink traffic, based on the jitter report configuration information in operation 501, the UE 500 may report measured jitter information to the core network 560 in operation 502. When identification information for uplink traffic is included in the jitter report configuration information in operation 501, the UE may report jitter measurement information for the corresponding uplink traffic in operation 502. When period information for the jitter report is included in the jitter report configuration information in operation 501, the UE may report the jitter measurement report according to the configured period information in operation 502. In operation 503, the core network 560 transmits traffic characteristic information of XR service data to a gNB 550. In operation 505, the gNB 550 may acquire traffic characteristic information of XR service data provided by the core network 560. The traffic characteristic information of the XR service data may be TSCAI_XR information. The traffic characteristic information of the XR service data acquired in operation 505 may include traffic characteristic information for uplink traffic and downlink traffic corresponding to the XR service. The traffic characteristic information may include, for example, at least one or a combination of a PDU session of the UE, a flow direction (downlink or uplink) for QoS flow, a downlink traffic period (DL periodicity, an uplink traffic period (UL periodicity), N6 jitter related to a downlink traffic period (DL periodicity), burst arrival time, and jitter related to uplink traffic which the UE 500 reported to the core network 560 in operation 502 (jitter may be independently expressed for uplink traffic or may be expressed as jitter associated with the uplink traffic period according to an embodiment). The gNB 550 may acquire, from the traffic characteristic information of the XR service in operation 505, traffic characteristic information of the UE 500 including jitter corresponding to uplink traffic which the UE 500 reported to the core network 560. The gNB 550 may process downlink scheduling and uplink scheduling for a DRB corresponding to each QoS flow and a C-DRX configuration by using the traffic characteristic information of the XR service data in operation 505.

Although the case where the jitter information corresponding to the uplink traffic of the UE 500 is transmitted while being included in the traffic characteristic information of the XR service data in operation 503 is described in the embodiment of FIG. 5, separate signaling indicating the jitter information for uplink traffic may be transmitted in another embodiment.

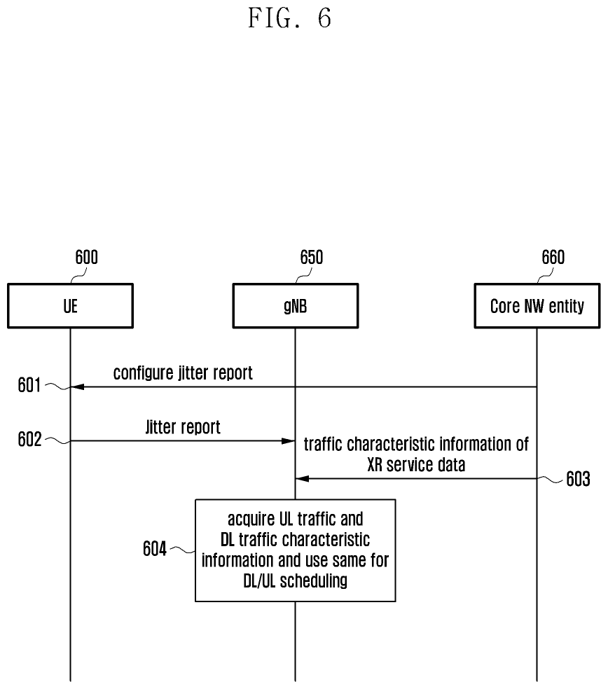

FIG. 6 illustrates signaling through which a UE reports jitter for uplink traffic to a network according to an embodiment of the disclosure.

Referring to FIG. 6, a UE 600 may receive jitter report configuration information for uplink traffic from a core network 660 in operation 601. The jitter report configuration information in operation 601 may include at least one or a combination of a PDU session ID corresponding to uplink traffic, a QoS flow ID, and UL traffic periodicity, and is information for which a request is made by the UE for the PDU session or QoS flow included in the configuration information in operation 601. The configuration information in operation 601 may include at least one or a combination of period information for making the jitter report by the UE, for example, a period for periodically making the jitter report, threshold information of a jitter value that makes the jitter report, and threshold information of a jitter value variation that performs the jitter report. When there is a jitter value measured for uplink traffic, based on the jitter report configuration information in operation 601, the UE 600 may report the measured jitter information to a gNB 650 in operation 602. When identification information for uplink traffic is included in the jitter report configuration information in operation 601, the UE may report jitter measurement information for the uplink traffic in operation 602. When period information for the jitter report is included in the jitter report configuration information in operation 601, the UE may report the jitter measurement report according to the configured period information in operation 602. Although not illustrated in FIG. 6, the UE 600 may be configured to operate a timer to control frequency of the uplink jitter report which the UE 600 transmits to the gNB 650. The timer may be a timer including at least one or a combination of jitterReportingProhibitTimer (the jitter report is not made before the timer has expired) or delay BudgetReportingProhibitTimer (the jitter report is not made before the time has expired). In operation 603, the core network 660 transmits traffic characteristic information of XR service data to the gNB 650. In operation 604, the gNB 650 may acquire traffic characteristic information of XR service data provided by the core network 660. The traffic characteristic information of the XR service data may be TSCAI_XR information. The traffic characteristic information of the XR service data acquired in operation 604 may include traffic characteristic information for uplink traffic and downlink traffic corresponding to the XR service. The traffic characteristic information may include, for example, at least one or a combination of a PDU session of the UE, a flow direction (downlink or uplink) for QoS flow, a downlink traffic period (DL periodicity), an uplink traffic period (UL periodicity), N6 jitter related to a downlink traffic period (DL periodicity), and burst arrival time. The gNB 650 may acquire, from the traffic characteristic information of the XR service in operation 604, uplink traffic characteristic information other than jitter corresponding to uplink traffic acquired from the UE 600 in operation 602. The gNB 650 may process downlink scheduling and uplink scheduling for a DRB corresponding to each QoS flow and a C-DRX configuration by using the uplink jitter information in operation 602 and the traffic characteristic information of the XR service data in operation 604. Although not illustrated in FIG. 6, the gNB 650 may provide the core network 660 with jitter information for uplink traffic acquired from the UE 600 in operation 602, and the jitter information includes at least one or a combination of a PDU session mapped to uplink traffic, QoS flow, UL jitter, and UL traffic periodicity. Based on the information, the core network 660 may configure traffic characteristic information of XR service data including UL jitter information for the PDU session mapped to the corresponding uplink traffic in the UE.

In the embodiments of FIGS. 3 to 6, an embodiment of jitter information corresponding to uplink traffic which can be included in an RRC message (for example, UEAssistanceInformation message) which the UE transmits to the gNB may include Table 1.

```
TABLE 1
  UEAssistanceInformation-Ies ::= SEQUENCE {
  jitterReportJitterReport OPTIONAL,
      ...
  }
  JitterReport::= SEQUENCE {
```

| | |
|---|---|
| qosFlowID | QoS flow identifier corresponding to uplink traffic, PDU session |

ID corresponding to uplink traffic, or DRB ID corresponding to uplink traffic may be
reported. Alternatively, identification information that informs of CG configuration
corresponding to logical channel ID/logical channel group ID of uplink traffic or DRB
ID/logical channel ID/logical channel group ID of uplink traffic may be reported.

| | |
|---|---|
| jitter | For example, specific value or range may be expressed as |

measured jitter value

| | |
|---|---|
| ulPeriodicity | Uplink traffic period (UL traffic periodicity) related to measured |

```
jitter value may be reported.
  ...
  }
```

In the embodiments of FIGS. 3 to 6, an embodiment of jitter information corresponding to uplink traffic which can be included in an RRC message (for example, UEAssistanceInformation message) which the UE transmits to the gNB may include Table 2. In an embodiment of Table 2, jitter information corresponding to uplink traffic may be processed as expansion of delay budget information.

```
TABLE 2
  UEAssistanceInformation-IEs ::= SEQUENCE {
  delayBudgetReportDelayBudgetReportOPTIONAL,
  lateNonCriticalExtension OCTET STRING OPTIONAL,
  nonCriticalExtension UEAssistanceInformation-v1540-IEs
OPTIONAL
  }
  DelayBudgetReport::= CHOICE {
    type1 ENUMERATED {msMinus1280, msMinus640, msMinus320,
msMinus160,msMinus80, msMinus60, msMinus40, msMinus20, ms0, ms20,ms40,
ms60, ms80, ms160, ms320, ms640, ms1280},
IE extension for jitter reporting // DelayBudgetReportExtension
    ...
  }
  DelayBudgetReportExtension::= SEQUENCE {
```

| | |
|---|---|
| qosFlowID | QoS flow identifier corresponding to uplink traffic, PDU session |

ID corresponding to uplink traffic, or DRB ID corresponding to uplink traffic may be
reported. Alternatively, identification information that informs of CG configuration
corresponding to logical channel ID/logical channel group ID of uplink traffic or DRB
ID/logical channel ID/logical channel group ID of uplink traffic may be reported.

| | |
|---|---|
| jitter | For example, specific value or range may be expressed as |

measured jitter value

| | |
|---|---|
| ulPeriodicity | Uplink traffic period (UL traffic periodicity) related to measured |

```
jitter value may be reported.
  ...
  }
```

In the embodiments of FIGS. 3 to 6, an embodiment of jitter information corresponding to uplink traffic which can be included in an RRC message (for example, UEAssistanceInformation message) which the UE transmits to the gNB may include Table 3. In an embodiment of Table 3, jitter information corresponding to uplink traffic may be processed as expansion of delay budget information. Further, the embodiment of Table 3 may be used to control configured grant (CG) scheduling, based on the jitter information reported by the UE when the gNB supports configured grant (CG) scheduling for uplink traffic of the UE.

```
TABLE 3
  UEAssistanceInformation-IEs ::= SEQUENCE {
  delayBudgetReportDelayBudgetReport OPTIONAL,
  lateNonCriticalExtension OCTET STRING OPTIONAL,
  nonCriticalExtension UEAssistanceInformation-v1540-IEs
OPTIONAL
  }
  DelayBudgetReport::= CHOICE {
    type 1 ENUMERATED {msMinus1280, msMinus640, msMinus320,
msMinus160,msMinus80, msMinus60, msMinus40, msMinus20, ms0, ms20,ms40,
ms60, ms80, ms160, ms320, ms640, ms1280},
    IE extension for jitter reporting // DelayBudgetReportExtension
    ...
  }
  DelayBudgetReportExtension::= SEQUENCE {
```

| | |
|---|---|
| qosFlowID | QoS-FlowIdentity, // QoS flow identifier corresponding to |

uplink traffic, PDU session ID corresponding to uplink traffic, DRB ID corresponding
to uplink traffic, or identification information that informs of CG configuration
corresponding to logical channel ID/logical channel group ID of uplink traffic or DRB
ID/logical channel ID/logical channel group ID of uplink traffic may be reported

| | |
|---|---|
| jitter | Jitter-Value, // For example, specific value or range may be |

expressed as measured jitter value

| | |
|---|---|
| cgPeriodicity | configuredGrantPeriodicity, // CG period (periodicity) |

```
related to measured jitter value may be reported (for example, it can be used when a
time point at which traffic arrives at a UE buffer changes by jitter value from CG period
which gNB configured in UE. It can be expressed as positive or negative value (for
example, positive expression may indicate case where arrival becomes later than
configured CG period and thus delay is generated, and negative expression may
indicate case where arrival becomes earlier than configured CG period).
  ...
  }
```

In the embodiments of FIGS. 3 to 6, an embodiment of jitter information corresponding to uplink traffic which can be included in a non-access-stratum (NAS) message which the UE transmits to a core network entity may include Table 4. The NAS message that can report jitter information corresponding to uplink traffic may include a (SMF-initiated) PDU session modification command procedure (modification complete message) or a new report procedure (report message).

TABLE 4
JitterReport::= SEQUENCE {

| | |
|---|---|
| qosFlowID | QoS flow identifier corresponding to uplink traffic or PDU |

session ID corresponding to uplink traffic may be reported.

| | |
|---|---|
| jitter | For example, specific value or range may be expressed as |

measured jitter value

| | |
|---|---|
| ulPeriodicity | Uplink traffic period (UL traffic periodicity) related to measured |

```
jitter value may be reported.
  ...
  }
```

In the embodiments of FIGS. 3 to 6, an embodiment of information in which the gNB configures the jitter report so that the UE reports jitter corresponding to uplink traffic may include Table 5. Table 5 may be included in an RRC message which the gNB transmits to the UE.

```
TABLE 5
  Indication indicating transmission of jitter report
  OtherConfig ::= SEQUENCE {
  jitterReportingConfig ENUMERATED {true} OPTIONAL, -- Need M
    ...
  }
  QoS flow information to make jitter report (at least one or combination of QoS
flow ID corresponding to uplink traffic, PDU session ID, DRB ID, logical channel ID,
logical channel group ID, configured grant configuration index)
  OtherConfig ::= SEQUENCE {
  jitterReportingConfigSetupRelease {JitterReportingConfig} OPTIONAL, --
Need M
    ...
  }
  JitterReportingConfig ::= SEQUENCE {
```

| | |
|---|---|
| qosFlowID | QoS-FlowIdentity // list of QoS flow ID, PDU session ID, DRB |

```
ID, logical channel ID, logical channel group ID, configured grant configuration index,
and the like
  }
  Configuration information for jitter report period
```

| | |
|---|---|
| • | For example, OtherConfig IE may configure prohibit timer information |

(at least one or combination of jitterReportingProhibitTimer and
delayBudgetReportingProhibitTimer) that limits jitter report corresponding to uplink in
UEAssistanceInformation message.

| | |
|---|---|
| • | jitterReportingProhibitTimer: prohibit timer for jitter reporting. value in |

```
seconds. Value s0 means prohibit timer is set to 0 seconds, value s0dot4 means
prohibit timer is set to 0.4 seconds, and so on.
  OtherConfig ::= SEQUENCE {
  jitterReportingConfigSetupRelease {JitterReportingConfig} OPTIONAL, --
Need M
    ...
  }
  JitterReportingConfig ::= SEQUENCE {
  JitterReportingProhibitTimer ENUMERATED {a, b, c, d, e, f, g, h}
  }
```

| | |
|---|---|
| • | delayBudgetReportingProhibitTimerXR: prohibit timer used for |

expanded delay budget report for jitter report. Value in seconds. Value s0 means
prohibit timer is set to 0 seconds, value s0dot4 means prohibit timer is set to 0.4
seconds, and so on.

| | |
|---|---|
| • | For example, OtherConfig IE may configure at least one or combination |

of period (report period) of jitter report corresponding to uplink and threshold value in
UEAssistanceInformation message.

| | |
|---|---|
| • | Report period: configures report period so that UE can periodically make |

jitter report

| | |
|---|---|
| • | Jitter value threshold: reference value to make jitter report by UE |

(reported when jitter value is larger than (or equal to) threshold value or reported when
jitter value is smaller than (or equal to) threshold value)

| | |
|---|---|
| • | Jitter value variation threshold: reference value of jitter value variation |

```
to make jitter report by UE (reported when jitter variation is larger than (or equal to)
threshold value compared to previously reported value and reported when jitter
variation is larger than (or equal to) threshold absolute value)
    •
  JitterReportingConfig::= SEQUENCE {
```

| | |
|---|---|
| qosFlowID | QoS-FlowIdentity, // configured to report jitter for QoS flow |

identifier corresponding to uplink traffic or PDU session ID corresponding to uplink
traffic. Alternatively, it may be configured to report jitter for identification information
that informs of CG configuration corresponding to logical channel ID/logical channel
group ID of uplink traffic or DRB ID/logical channel ID/logical channel group ID of
uplink traffic.

| | |
|---|---|
| ulPeriodicity | Periodicity, // configured to report jitter for uplink traffic period |

```
(UL traffic periodicity).
  ...
  }
```

In the embodiments of FIGS. 3 to 6, an embodiment of information in which the core network configures the jitter report so that the UE reports jitter corresponding to uplink traffic may include Table 6. Table 6 may be included in an NAS message which the core network transmits to the UE. The NAS message for configuring the jitter report corresponding to uplink traffic may include a (UE-initiated) PDU session establishment procedure (response message), a (SMF-initiated) PDU session modification command procedure (command message), or a new report procedure (report request message).

TABLE 6
JitterReportConfig::= SEQUENCE {

| | |
|---|---|
| qosFlowID | QoS-FlowIdentity, // configured to report jitter for QoS flow |

identifier corresponding to uplink traffic or PDU session ID corresponding to uplink
traffic.

| | |
|---|---|
| ulPeriodicity | Periodicity, // configured to report jitter for uplink traffic period |

```
(UL traffic periodicity)
  jitterReportFrequency, // period information for jitter report (report period to be
applied when jitter report is periodically made, threshold vale of jitter value to make
jitter report, threshold value of jitter value variation to make jitter report, and the like)
  ...
  }
```

According to various embodiments of the disclosure, in the embodiments of FIGS. 3 and 4, the core network may transmit a message making a request for traffic information (for example, a PDU session corresponding to uplink traffic, QoS flow, and jitter information for uplink traffic for UL periodicity information) determined such that jitter information is needed for uplink traffic of the UE to the gNB in order to allow the gNB to perform an operation of configuring the jitter report to the UE to receive the jitter report corresponding to uplink traffic of the UE and receiving the jitter report for uplink traffic from the UE. The uplink traffic jitter information request message may be transferred from the core network to the gNB through a traffic characteristic information message of XR service data including traffic characteristic information corresponding to the XR service or a separate uplink traffic jitter information request message. The message may be a TSCAI_XR message. When receiving the uplink traffic jitter information request message from the core network, the gNB may transmit the jitter report configuration (for example, Table 5) corresponding to uplink traffic to the UE with reference to information on the jitter information request message.

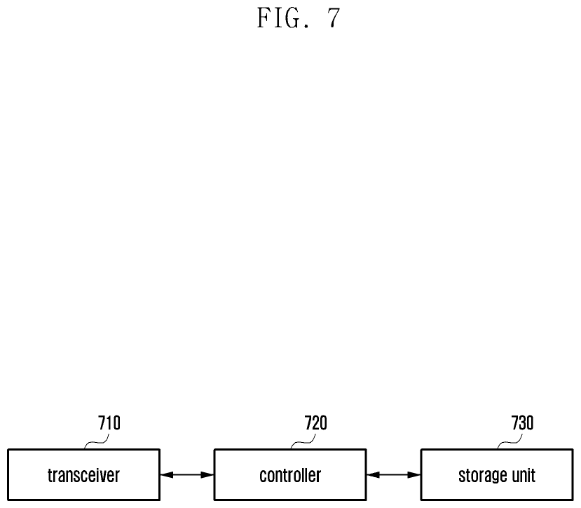

FIG. 7 illustrates a structure of a base station according to an embodiment of the disclosure.

Referring to FIG. 7, the base station may include a transceiver 710, a controller 720, and a storage unit 730. According to the communication method of the base station, the transceiver 710, the controller 720, and the storage unit 730 may operate. A network device may also correspond to the structure of the base station. However, the elements of the base station are not limited to the above example. For example, the base station may include more or fewer elements than the above-described elements. For example, the base station may include the transceiver 710 and the controller 720. Further, the transceiver 710, the controller 720, and the storage unit 730 may be implemented in the form of a single chip.

The transceiver 710 collectively refers to a receiver of the base station and a transmitter of the base station, and may transmit and receive signals to and from the UE, another base station, or other network devices. At this time, the transmitted and received signals may include control information and data. The transceiver 710 may transmit, for example, system information to the UE and transmit a synchronization signal or a reference signal. To this end, the transceiver 710 may include an RF transmitter for up-converting and amplifying a frequency of a transmitted signal and an RF receiver for low-noise amplifying a received signal and down-converting the frequency. However, this is only an embodiment of the transceiver 710, and the elements of the transceiver 710 are not limited to the RF transmitter and the RF receiver. The transceiver 710 may include a wired/wireless transceiver and include various elements for transmitting and receiving signals. Further, the transceiver 710 may receive a signal through a communication channel (for example, a radio channel), output the signal to the controller 720, and transmit the signal output from the controller 720 through the communication channel. In addition, the transceiver 710 may receive a communication signal, output the communication signal to the processor, and transmit the signal output from the processor to the UE, another BS, or another entity through a wired/wireless network.

The storage unit 730 may store programs and data required for the operation of the base station. Further, the storage unit 730 may store control information or data included in signals acquired by the base station. The storage unit 730 may be configured by storage media, such as read only memory (ROM), random access memory (RAM), hard disk, compact disc (CD)-ROM, and digital versatile disc (DVD), or a combination of the storage media. The storage unit 730 may store at least one piece of information transmitted and received through the transceiver 710 and information generated through the controller 720.

In the disclosure, the controller 720 may be defined as a circuit, an application-specific integrated circuit, or at least one processor. The processor may include a communications processor (CP) that performs control for communication, and an application processor (AP) that controls higher layers, such as an application layer. The controller 720 may control overall operation of the base station according to embodiments proposed in the disclosure. For example, the controller 720 may control a signal flow between blocks to perform the operation according to the above-described flowchart.

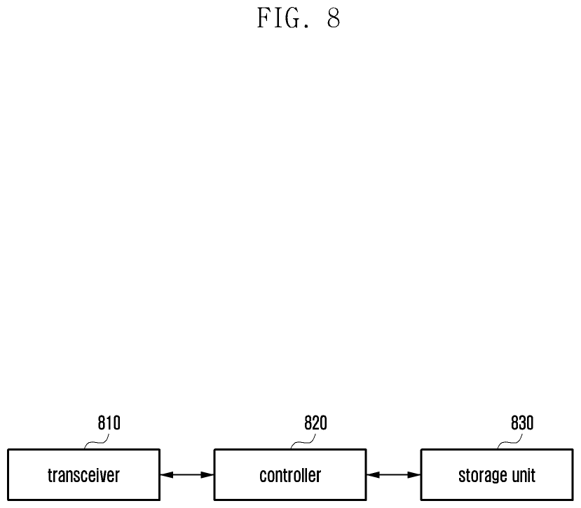

FIG. 8 illustrates a structure of a UE according to an embodiment of the disclosure.

Referring to FIG. 8, the UE may include a transceiver 810, a controller 820, and a storage unit 830. The transceiver 810, the controller 820, and the storage unit 830 may operate according to a communication method of the UE. However, the elements of the UE are not limited to the above example. For example, the UE may include more or fewer elements than the above elements. For example, the UE may include the transceiver 810 and the controller 820. Further, the transceiver 810, the controller 820, and the storage unit 830 may be implemented in the form of a single chip.

The transceiver 810 collectively refers to a receiver of the UE and a transmitter of the UE, and may transmit and receive signals to and from the base station, another UE, or network entities. The signals transmitted and received to and from the base station may include control information and data. The transceiver 810 may receive, for example, system information from the BS and receive a synchronization signal or a reference signal. To this end, the transceiver 810 may include an RF transmitter for up-converting and amplifying a frequency of a transmitted signal and an RF receiver for low-noise amplifying a received signal and down-converting the frequency. However, this is only an embodiment of the transceiver 810, and the elements of the transceiver 810 are not limited to the RF transmitter and the RF receiver. The transceiver 810 may include a wired/wireless transceiver and various elements for transmitting and receiving a signal. Further, the transceiver 810 may receive a signal through a radio channel, output the signal to the controller 820, and transmit the signal output from the controller 820 through the radio channel. The transceiver 810 may receive a communication signal, output the communication signal to the processor, and transmit the signal output from the processor to a network entity through a wired/wireless network.

The storage unit 830 may store programs and data required for the operation of the UE. Further, the storage unit 830 may store control information or data included in a signal acquired by the UE. The storage unit 830 may be configured by storage media, such as ROM, RAM, hard disks, CD-ROMs, and DVDs, or a combination of the storage media.

In the disclosure, the controller 820 may be defined as a circuit, an application-specific integrated circuit, or at least one processor. The processor may include a communications processor (CP) that performs control for communication, and an application processor (AP) that controls higher layers, such as an application layer. The controller 820 may control overall operation of the UE according to embodiments proposed in the disclosure. For example, the controller 820 may control a signal flow between blocks to perform the operation according to the above-described flowchart.

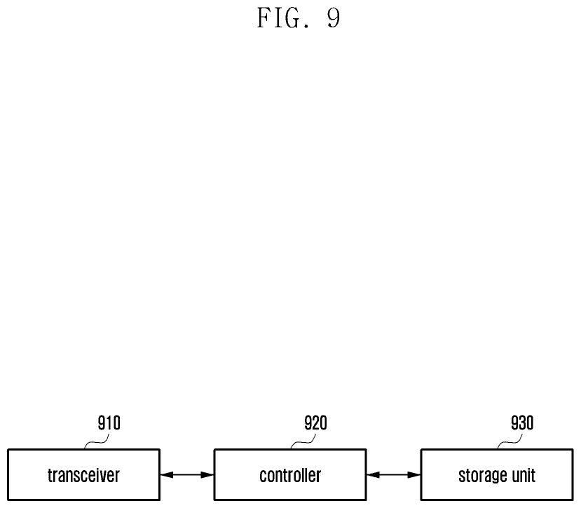

FIG. 9 illustrates a structure of a core network entity (or a network function) according to an embodiment of the disclosure. The structure of the core network entity (or network function) illustrated in FIG. 9 may be applied to not only the network entity (or network function) described in FIGS. 1 to 6 but also another network entity (or network function).

Referring to FIG. 9, the core network entity (or network function) may include a transceiver 910, a controller 920, and a storage unit 930. According to the communication method of the network entity (or network function), the transceiver 910, the controller 920, and the storage unit 930 may operate. However, the elements of the network entity (or network function) are not limited to the above-described example. For example, the network entity (or network function) may include more elements or fewer elements than the above-described elements. For example, the network entity (or network function) may include the transceiver 910 and the controller 920. Further, the transceiver 910, the controller 920, and the storage unit 930 may be implemented in the form of a single chip.

The transceiver 910 collectively refers to a receiver of the network entity (or network function) and a transmitter of the network entity (or network function), and may transmit and receive signals to and from the base station, the UE, or another network entity (network function). The transceiver 910 may transmit a signal making a request for user permission to the UE through the base station or receive information for informing of user permission-related approval or disposal from the UE through the base station. To this end, the transceiver 910 may include a wired/wireless transceiver, and include various configurations for transmitting and receiving signals. Further, the transceiver 910 may receive signals through a radio channel or a wired backhaul network, output the signals to the controller 920, and transmit the signal output from the controller 920 through the radio channel. Further, the transceiver 910 may receive a communication signal, output the communication signal to the processor, and transmit the signal output from the processor to a network entity through a wired/wireless network.

The storage unit 930 may store programs and data required for the operation of the network entity (or network function). Further, the storage unit 930 may store control information or data included in signals acquired from the network entity (or network function). The storage unit 930 may be configured by storage media, such as ROM, RAM, hard disk, CD-ROM, and DVD, or a combination of the storage media.

In the disclosure, the controller 920 may be defined as a circuit, an application-specific integrated circuit, or at least one processor. The processor may include a communications processor (CP) that performs control for communication, and an application processor (AP) that controls higher layers, such as an application layer. The controller 920 may control overall operation of the network entity (or network function) according to embodiments proposed in the disclosure. For example, the controller 920 may control a signal flow between blocks to perform the operation according to the above-described flowchart.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including random access memory (RAM) and flash memory, read only memory (ROM), electrically erasable programmable read only memory (EEPROM), magnetic disc storage device, compact disc-ROM (CD-ROM), digital versatile discs (DVDs), or other type optical storage devices, or a magnetic cassette. Alternatively, any combination of some or all of them may form memory in which the program is stored. Furthermore, a plurality of such memories may be included in the electronic device.

In addition, the programs may be stored in an attachable storage device which may access the electronic device through communication networks, such as the Internet, Intranet, local area network (LAN), wide LAN (WLAN), and storage area network (SAN) or a combination thereof. Such a storage device may access the electronic device via an external port. Furthermore, a separate storage device on the communication network may access a portable electronic device.

In the disclosure, the term “computer program product” or “computer readable medium” is used to generally refer to a medium, such as memory, a hard disk installed in a hard disk drive, or a signal. The “computer program product” or “computer readable medium” is an element that is provided to a method for reporting UE capability in a wireless communication system according to the disclosure.

The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium. As an example, the “non-transitory storage medium” may include a buffer in which data is temporarily stored.

According to an embodiment of the disclosure, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. For example, it will be apparent to those skilled in the art that other variants based on the technical idea of the disclosure may be implemented. Furthermore, the above respective embodiments may be employed in combination, as necessary. For example, one embodiment of the disclosure may be partially combined with any other embodiment to operate a base station and a terminal. In addition, the embodiments of the disclosure may be applied to other communication systems and other variants based on the technical idea of the embodiments may also be implemented. For example, the embodiments may be applied to LTE, 5G, NR, or 6G systems. Therefore, the scope of the disclosure should not be defined as being limited to the embodiments set forth herein, but should be defined by the appended claims and equivalents thereof.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station, a first message including a configuration associated with a jitter report of an uplink traffic; and
transmitting, to the base station, a second message including the jitter report,
wherein the configuration includes at least one of information on a protocol data unit (PDU) session or information on a timer.

2. The method of claim 1,
wherein the information on the PDU session includes at least one of PDU session identifier or quality of service (QOS) flow identifier, and
wherein the timer is associated with T346x.

3. The method of claim 1,
wherein the jitter report includes information on an uplink traffic, and
wherein the information on uplink traffic includes at least one of a PDU session identifier or information on a QoS flow.

4. The method of claim 3, wherein the information on a QoS flow includes at least one of a QoS flow identifier (QFI), a jitter range, or a traffic periodicity.

5. The method of claim 1, wherein the second message is a UEAssistanceInformation message.

6. A method performed by a base station in a wireless communication system, the method comprising:
transmitting, to a user equipment (UE), a first message including a configuration associated with a jitter report of an uplink traffic; and
receiving, from the UE, a second message including the jitter report,
wherein the configuration includes at least one of information on a protocol data unit (PDU) session or information on a timer.

7. The method of claim 6,
wherein the information on the PDU session includes at least one of PDU session identifier or quality of service (QOS) flow identifier, and
wherein the timer is associated with T346x.

8. The method of claim 6,
wherein the jitter report includes information on an uplink traffic, and
wherein the information on uplink traffic includes at least one of a PDU session identifier or information on a QoS flow.

9. The method of claim 8, wherein the information on a QoS flow includes at least one of a QoS flow identifier (QFI), a jitter range, or a traffic periodicity.

10. The method of claim 6, wherein the second message is a UEAssistanceInformation message.

11. A user equipment (UE) in a wireless communication system, the UE comprising:
a transceiver; and
a controller operably connected to the transceiver, the controller configured to:
receive, from a base station, a first message including a configuration associated with a jitter report of an uplink traffic, and
transmit, to the base station, a second message including the jitter report,
wherein the configuration includes at least one of information on a protocol data unit (PDU) session or information on a timer.

12. The UE of claim 11,
wherein the information on the PDU session includes at least one of PDU session identifier or quality of service (QOS) flow identifier, and
wherein the timer is associated with T346x.

13. The UE of claim 11,
wherein the jitter report includes information on an uplink traffic, and
wherein the information on uplink traffic includes at least one of a PDU session identifier or information on a QoS flow.

14. The UE of claim 13, wherein the information on a QoS flow includes at least one of a QoS flow identifier (QFI), a jitter range, or a traffic periodicity.

15. The UE of claim 11, wherein the second message is a UEAssistanceInformation message.

16. A base station in a wireless communication system, the base station comprising:
a transceiver; and
a controller operably connected to the transceiver, the controller configured to:
wherein the one or more computer programs include computer-executable instructions that, when executed by the one or more processors, cause the base station to:
transmit, to a user equipment (UE), a first message including a configuration associated with a jitter report of an uplink traffic, and
receive, from the UE, a second message including the jitter report,
wherein the configuration includes at least one of information on a protocol data unit (PDU) session or information on a timer.

17. The base station of claim 16,
wherein the information on the PDU session includes at least one of PDU session identifier or quality of service (QOS) flow identifier, and
wherein the timer is associated with T346x.

18. The base station of claim 16,
wherein the jitter report includes information on an uplink traffic, and
wherein the information on uplink traffic includes at least one of a PDU session identifier or information on a QoS flow.

19. The base station of claim 18, wherein the information on a QoS flow includes at least one of a QoS flow identifier (QFI), a jitter range, or a traffic periodicity.

20. The base station of claim 16, wherein the second message is a UEAssistanceInformation message.
